(19) United States
(12) Patent Application Publication
(10) Pub. No.: US 2023/0086975 A1
(43) Pub. Date: Mar. 23, 2023

(54) EQUIPMENT FOR THE FILTRATION OF A SUSPENSION USING A ROTARY PRECOAT FILTER

(71) Applicant: G.S.-TRADING S. A., Holzem (LU)

(72) Inventor: Nicolas ADAMI, Marly (FR)

(21) Appl. No.: 17/904,566

(22) PCT Filed: Feb. 27, 2020
(86) PCT No.: PCT/EP20/55083

§ 371 Date: Aug. 18, 2022

(51) Int. Cl. B01D 33/80; B01D 37/02

(52) U.S. Cl. CPC B01D 33/803; B01D 37/02

(57) ABSTRACT

The equipment for the filtration of a suspension uses a rotary filter with a precoat. The equipment includes a filtration unit for the implementation of the rotary filter and a coating unit for coating the rotary filter with the precoat. The coating unit is independent of the filtration unit.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to equipment for filtration, by means of a rotary filter, of liquids laden with mineral or organic particles.

### 2. Description of Related Art Including Information Disclosed Under 37 CFR 1.97 and 37 CFR 1.98.

At present, many industries involve process steps requiring the implementation of a filtration solution allowing the purification of liquid products and/or the recovery, for various purposes, of the solid substances suspended in them.

The solution for this purpose involving the use of one or more rotary filters has been known and used for many years in many industries. In classical manner, the filtration on a rotary filter can be carried out simply with the aid of a filter cloth. However, for more demanding applications requiring a more effective and high-quality filtration, it is also customary to coat the rotary filter in advance with a precoat formed by organic and/or mineral compounds having filtering and/or absorbing and/or adsorbing properties.

For this purpose, the current practice is to form the filtering and/or absorbing and/or adsorbing precoat on the surface of the rotary filter, directly in the vessel designed for the filtration, and to inject in the latter the laden liquid to be filtered once the precoat coating the rotary filter has reached the required thickness for the application.

This technique is very effective, and is in widespread use at present. However, it has been observed that at the start of forming the precoat, as well as at the end of the filtration, a certain quantity of mineral and/or organic particles forming the precoat are liable to migrate from the latter to the filtered liquid. Although in general this quantity of particles released by the precoat is very slight, and does not present any problems in most instances, there are, however, applications for which one must guarantee that absolutely no solid particle can contaminate the filtered liquid.

Such is the case for instance when filtering, for purposes of recycling, the etching baths of polymer plates intended for flexographic printing. In fact, the products recommended in this case for making the filtration precoat covering the filter being used are most often very abrasive. And if only two or three particles are found in the filtered liquid, that is enough to totally ruin the quality of the etching and thus the ultimate printing.

A similar concern involves the field of filtration of biological liquids, such as human blood, or the filtration of products for medicinal use, in which the purity of the resulting end products is a crucial necessity.

Albeit to a lesser extent, the same issues occur in the field of filtration of food-quality liquids, such as certain alcohols.

### BRIEF SUMMARY OF THE INVENTION

In this context, the purpose of the present invention is to propose a solution for a filtration by rotary filter with precoat, alternative to the existing ones, which allows both a filtering of a liquid product laden with solid substances in an efficient manner and an avoidance of any presence of organic and/or mineral particles coming from the precoat in the filtered liquid, and consequently guaranteeing the degree of purity of the latter.

For this purpose, the present invention relates to equipment for the filtration of a suspension by using a rotary filter with precoat, comprising a filtration unit designed to implement said rotary filter, characterized in that it further comprises a coating unit for coating the rotary filter with the precoat, said coating unit being independent of said filtration unit.

According to one preferred variant embodiment, the equipment according to the invention comprises means of automatic displacement of the rotary filter between said filtration unit and coating unit.

Furthermore, the invention also advantageously proposes that the coating unit and the filtration unit each comprise a vessel adapted to house said rotary filter longitudinally as well as means for detection of the thickness of the precoat covering the rotary filter.

An additional characteristic of the equipment according to the invention is defined by the fact that it further comprises a preparation unit for a suspension which will form the precoat, said preparation unit being independent of said filtration unit.

According to one preferred variant embodiment, the preparation unit comprises a vessel provided with means of agitation and connected to said coating unit by a fluidic circuit.

According to one characteristic of the invention, the fluidic circuit comprises a feed line and a drainage line connecting the vessel of the preparation unit for a suspension to the vessel of the coating unit, each of the lines being connected to a pump adapted to allow the circulation of the suspension used for the preparation of the precoat between the vessel of the preparation unit and the vessel of the coating unit and vice versa.

Furthermore, it has also been devised in the context of the present invention that the means for automatic displacement of the rotary filter between said filtration unit and coating unit comprise a first and a second pneumatic jack connected to the rotation shaft of the rotary filter and adapted to allow a translatory displacement of the rotary filter respectively along a vertical axis perpendicular to its rotation shaft and along a horizontal axis perpendicular to its rotation shaft.

Another characteristic of the equipment according to the invention is defined by the fact that the filtration unit is provided with a doctoring means for the filtering precoat coating the rotary filter, forming a single piece with the vessel to which it belongs.

Furthermore, the present filtration equipment is also characterized in that the vessel of the filtration unit has an entry orifice for the suspension being filtered, said entry orifice being connected optionally to an inlet line for the suspension being filtered, provided with a pump.

### BRIEF DESCRIPTION OF THE SEVERAL VIEWS OF THE DRAWINGS

The description should be read in connection with the attached drawing.

FIG. 1 is a schematic view of the equipment according to the invention, illustrating the two positions (respectively in solid and dotted lines) which can be adopted by the rotary filter with precoat belonging to the equipment.

### DETAILED DESCRIPTION OF THE INVENTION

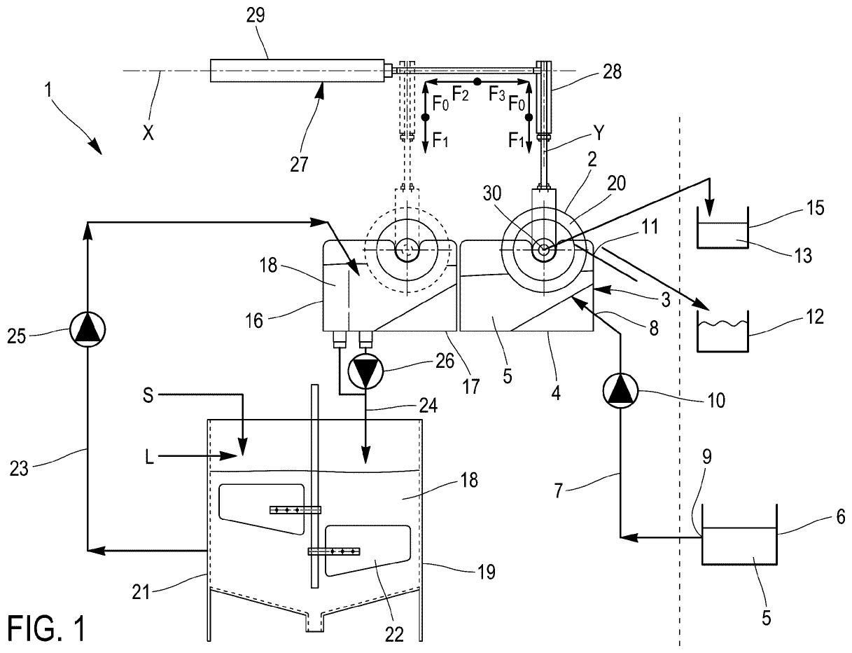

As illustrated in FIG. 1, in the variant embodiment shown, the equipment 1 for filtration of a suspension according to the invention comprises a rotary filter 2 with precoat 20 designed to be implemented within a filtration unit 3.

The latter is composed of a vessel 4 adapted to house the rotary filter 2 longitudinally and to receive the suspension 5 being filtered.

As illustrated in FIG. 1, in the variant embodiment shown, the suspension 5 being filtered is transferred from a storage tank 6 to the vessel 4 through a line 7, which is connected to an entry orifice 8 of the vessel 4 and to an exit orifice 9 of the storage tank 6. The suspension 5 is placed in circulation in the line 7 by means of a pump 10.

The filtration unit 3 further comprises a doctor blade 11 making it possible to progressively thin out the precoat 20 and thus remove, for example to a container 12, the solid particles initially contained in the suspension 5 and retained in the precoat 20.

The purified liquid 13 resulting from the filtration of the suspension 5 is drained in the area of the central channel 14 of the rotary filter 2 and collected in a container 14.

The filtration is automatically halted after detection of a certain thickness of the precoat 20 by a dedicated sensor (not shown) belonging to the filtration unit 3.

According to the invention, the equipment 1 further comprises a coating unit 16, independent of the filtration unit 3, and in which the precoat 20 is formed to cover the rotary filter 2 prior to implementing the filter during the filtration.

For this purpose, the coating unit 16 comprises a vessel 17, likewise adapted to house the rotary filter 2 longitudinally and to receive a suspension 18 which will form said precoat 20.

For this purpose, the filtration equipment 1 is provided with a preparation unit 19 for the suspension 18, consisting of a vessel 21, provided with an agitator 22, in which it is possible to introduce the liquid product L and the solid substance S which will serve to form the precoat 20. The vessel 21 is connected to the vessel 17 of the coating unit 16 by a fluidic circuit comprising a forward line 23 and a return line 24, both of them provided with a pump 25, 26.

Referring to FIG. 1, the equipment 1 according to the invention further comprises a system 27 for automatic displacement of the rotary filter 2 between the filtration unit 3 and the coating unit 16. This system 27 is composed of a first and a second pneumatic jack 28, 29, connected to the rotation shaft of the rotary filter 2 and adapted to allow a translatory displacement of the latter respectively in the two directions along a vertical axis Y (arrows F0, F1) perpendicular to its rotation shaft and in the two directions along a horizontal axis X (arrows F2, F3) perpendicular to its rotation shaft.

In practice, the equipment according to the invention may be used, for example, in the recycling of etching baths of polymer plates intended for flexographic printing, this process requiring a total elimination of the polymers suspended in the baths in order to guarantee the quality of the plates produced later on by means of these same baths.

The implementation of the equipment 1 involves first of all covering the rotary filter 2 with its precoat 20. For this purpose, a coating suspension 18 of appropriate composition is previously prepared in the vessel 21 of the preparation unit 19. When this is homogeneous and has reached the desired concentration, it is transferred to the vessel 17 of the coating unit 16, in which the rotary filter 2 has already been arranged. The latter is then actuated and placed in rotation until the thickness of the precoat 20, measured by means of a sensor (not shown) belonging to the coating unit 16, has reached the desired dimension.

When the process of forming the precoat 20 is finished, the rotary filter 2 is moved by means of the jacks 28, 29 from the coating unit 16 to the filtration unit 3, the vessel 4 of which contains a suspension 5 to be filtered, for example, an etching bath for polymer plates. As the filtering proceeds, the solid particles contained in the suspension 5 are retained in the precoat 20 of the rotary filter 2. These are progressively removed to the container 12 by permanent doctoring of the precoat 20 using the doctor blade 11 throughout the filtration process.

As indicated above, the filtration is halted automatically when the thickness of the precoat 20 reaches a predefined value as detected by the sensor belonging to the filtration unit 3. The rotary filter 2 is then sent back to the coating unit 16 for cleaning and a new cycle of formation of the precoat 20, which may be followed by a new phase of filtration.

It is clear from the preceding remarks that thanks to the presence of a coating unit 16 which is totally independent of the filtration unit 3, the equipment 1 according to the invention can guarantee that no solid particle meant to form the precoat 20 of the rotary filter 2 can contaminate the suspension being filtered 5. In fact, the phases of preparation of the precoat 20 and filtration are thus totally dissociated and the suspension 5 being filtered is never in contact with the suspension 18 designed to form the precoat 20. The fact that the equipment 1 likewise comprises a preparation unit 19 for the coating suspension 18 which is independent of the filtration unit 3 further contributes to achieving this advantage.

1. Equipment for filtration of a suspension, comprising:
a filtration unit having a rotary filter; and
a coating unit for coating the rotary filter with the precoat, said coating unit being independent of said filtration unit.

2. Equipment for filtration, according to claim 1, further comprising: means of automatic displacement of the rotary filter between said filtration unit and coating unit.

3. Equipment for filtration, according to claim 1, wherein the coating unit and the filtration unit each comprise a vessel adapted to house said rotary filter longitudinally as well as means for detection of the thickness of the precoat covering the rotary filter.

4. Equipment for filtration, according to claim 1 further comprising:
a preparation unit for a suspension which will form the precoat, said preparation unit being independent of said filtration unit.

5. Equipment for filtration, according to claim 4, wherein said preparation unit comprises a vessel provided with means of agitation and connected to said coating unit by a fluidic circuit.

6. Equipment for filtration, according to claim 5, wherein the fluidic circuit comprises a feed line and a drainage line connecting the vessel of the preparation unit for a suspension to the vessel of the coating unit, each of the lines being connected to a pump adapted to allow the circulation of the suspension used for the preparation of the precoat between the vessel of the preparation unit and the vessel of the coating unit and vice versa.

7. Equipment for filtration, according to claim 2, wherein the means for automatic displacement of the rotary filter between said filtration unit and coating unit comprise a first and a second pneumatic jack connected to the rotation shaft of the rotary filter and adapted to allow a translatory displacement of the rotary filter respectively along a vertical axis perpendicular to its rotation shaft and along a horizontal axis perpendicular to its rotation shaft.

8. Equipment for filtration, according to claim 3, wherein the filtration unit is provided with a doctoring means for the filtering precoat coating the rotary filter, forming a single piece with the vessel to which it belongs.

9. Equipment for filtration, according to claim 3, wherein the vessel of the filtration unit is comprised of an entry orifice for the suspension being filtered.

10. Equipment for filtration, according to claim 9, wherein the entry orifice is connected to an inlet line for the suspension being filtered, provided with a pump.
